(19) United States
(12) Patent Application Publication
(10) Pub. No.: US 2009/0061073 A1
(43) Pub. Date: Mar. 5, 2009

(54) CAST COATING DEVICE

(75) Inventors: Hans-Joachim Becher, Numbrecht (DE); Andreas Euler, Pulheim (DE); Thomas Grosser, Gladbach (DE); Willi Hammerschmidt, Gladbach (DE)

Correspondence Address: KNOBBE MARTENS OLSON & BEAR LLP, 2040 MAIN STREET, FOURTEENTH FLOOR, IRVINE, CA, 92614, US

(73) Assignee: M-Real Oyi

(21) Appl. No.: 11/994,497

(22) PCT Filed: Jun. 21, 2006
(86) PCT No.: PCT/EP2006/005964

§ 371 Date: May 30, 2008

(30) Foreign Application Priority Data
Jul. 2, 2005 (EP) 05014425.2

(51) Int. Cl. B05D 3/00; B05C 1/00

(52) U.S. Cl. 427/2.31; 118/200

(57) ABSTRACT

The present invention refers to a cast coating device for manufacturing cast coated paper and/or paperboard, comprising a cast coating cylinder for treating a coated base paper, the cast coating cylinder comprising a supporting material and at least one coating applied to the supporting material, characterized in that according to DIN 50133 the coating has a hardness value of 1000 HV or more, as well as to a process of manufacturing a cast coated paper.

The present invention refers to a cast coating device as well as to a process of producing cast coated paper.

Devices for manufacturing paper or paperboard generally comprise rolls or cylinders which guide and transport a paper web. When a smooth and/or glossy paper is to be produced, a calender or a cast coating device is often used in the finishing step.

In a calender, a paper web is contacted with calender rolls under high pressure (generally, at least ten calender rolls are present in a calender), whereby said contact has a significant effect on the surface properties of the paper. The paper is smoothened by this treatment, and the gloss of the paper is increased. Since the quality of the surface of the calender roll has an impact on the quality of the paper produced, strict requirements on the quality of the calender roll have to be met. The paper must adhere to the roll in a suitable way but, on the other hand, it must also be readily separable from the roll. In case a coated paper is calendered, the coating must be dried prior to the calendering step.

As an alternative to calendering in a cast coating process, in the finishing step a coated paper can be contacted with a heated cylinder having a specular surface which generally is a highly polished chromium layer. While the paper is contacted with the cylinder, the paper is dried and the structure of the surface of the specular casting cylinder is transferred to the surface of the coated paper. Using this process, a paper with high gloss and excellent smoothness can be obtained. Contrary to the calendering process, the pressure applied to the paper in a cast coating process is much lower. Thereby, a paper having a lower density and higher stiffness is obtained. Moreover, a cast coating device comprises one casting roll only, whereas a calender generally comprises at least ten calender rolls. In case the casting roll has a chromium layer, said layer has to be passivated rotationally in order to ensure that the quality of the paper surface is maintained. In order to passivate the chromium layer, the production of the paper or board is ceased and the chromium layer is treated with a passivating composition. After the passivating step, cast coated paper production resumes. The cast coated papers known in the art generally have a high ink set-off time which might cause problems in a subsequent print process.

In the prior art, it is disclosed that calender rolls may have a ceramic or metallic coating.

EP 0 870 867 B1 discloses a roll for a paper or board machine, which may be used in a calender and comprises a specific ceramic layer. Due to this specific ceramic layer, the finishing of paper or board can be performed more effectively.

It is not disclosed in the prior art that casting cylinders of a cast coating device have a hardness value of 1000 HV or more since, for instance, a chromium layer of a casting cylinder has a hardness of less than 900 HV.

The object of the present invention is to provide a cast coating device for the manufacture of cast coated paper or board, whereby the effectiveness of the manufacturing process is increased by reducing the downtime of the production process.

The technical problem underlying the present invention is solved by a cast coating device for manufacturing cast coated paper and/or paperboard, comprising a cast coating cylinder for treating a coated base paper, the cast coating cylinder comprising a supporting material and at least one coating being applied to the supporting material, characterized in that according to DIN 50133 the coating has a hardness value of 1000 HV or more.

In a preferred embodiment, the hardness of the coating of the cast coating cylinder is ≧1100 HV, even more preferred ≧1200 HV, preferably ≧1300 HV and most preferred >1400 HV.

In a preferred embodiment, the coating applied to the supporting material of the cast coating cylinder is a ceramic coating.

Preferably, the ceramic coating comprises a hard material selected from the group consisting of metal oxides, semimetal oxides, metal carbides, semimetal carbides, metal nitrides, semimetal nitrides, metal borides, semimetal borides or mixtures thereof.

In a preferred embodiment, the ceramic coating is a coating comprising at least one hard material in a metal matrix and/or metal oxide matrix, whereby the metal matrix and/or metal oxide matrix is preferably different from the hard material.

Preferably, the metal matrix and/or metal oxide matrix comprises a self-flowing alloy, whereby said self-flowing alloy has been liquefied when applied to the supporting material. In a preferred embodiment, the metal matrix and/or metal oxide matrix comprises at least one metal alloy selected from the group consisting of alloys of nickel, chromium, boron, silicon, cobalt or mixtures thereof, whereby said metal alloy is preferably a self-flowing alloy.

Suitable coatings can be applied by processes known in the art, like the HVOF coating process.

Preferably, the coating has a thickness of from 10 to 500 μm, even more preferred of from 20 to 400 μm, and most preferred of from 30 to 300 μm.

A suitable ceramic coating is sold under the trade name CeraCal by Voith Paper. The

roughness Rₐ of the coating of the cast coating cylinder preferably is less than 1.0 μm, measured according to DIN 4762. In a preferred embodiment, the roughness Rₐ is less than 0.7 μm, preferably less than 0.5 μm, even more preferred less than 0.2 μm, preferably less than 0.1 μm, even more preferred less than 0.09 μm, and most preferred less than 0.08 μm. In an alternative embodiment, the roughness Rₐ preferably is less than 0.07 μm, even more preferred less than 0.06 μm, preferably less than 0.05 μm, even more preferred less than 0.04 μm, and most preferred less than 0.03 μm.

Preferably, at least one coating of the cast coating cylinder is present on the supporting material of the cast coating cylinder which comes into contact with the coated base paper.

In a preferred embodiment, the cast coating device comprises a means for heating the cast coating cylinder. Moreover, preferably the cast coating device comprises a means for applying a coating composition to a base paper, whereby the means for applying the coating composition is arranged in the cast coating device so that the coating is applied to the base paper before the obtained coated base paper is brought into contact with the cast coating cylinder.

Preferably, the cast coating device comprises a roll as a means for pressing the coated base paper to the cast coating cylinder. In a preferred embodiment, the cast coating device comprises a means for removing the dried coated base paper from the cast coating cylinder.

A further aspect of the present invention is the provision of a process for manufacturing cast coated paper and/or paperboard comprising the steps of:
(a) applying a coating composition to at least one surface of a base paper;
(b) bringing the coated base paper into contact with the surface of a heated cast coating cylinder in order to dry the coated base paper, the cast coating cylinder comprising a supporting material and at least one coating applied to the supporting material, whereby the coating has a hardness value of 1000 or more; and
(c) removing the dried coated base paper from the cylinder surface.

Preferably, the coating composition applied to the base paper in step (a) is coagulated and/or solidified to a gel before being brought into contact with the cylinder surface in step (b).

In a preferred embodiment, the coating composition applied to the base paper in step (a) is dried before being brought into contact with the cylinder surface in step (b), whereby the dried coat is remoistened before or simultaneously when being brought into contact with the cylinder surface.

Preferably, in step (b) the cylinder surface has a temperature of from 80° C. to 160° C.

In a preferred embodiment, in step (b), the coated base paper is pressed to the cylinder surface by means of a roll at a nip pressure of at least 1000 N/cm².

Preferably, in step (a) the coating composition applied to the base paper has a coat weight (oven-dry) of from 10 to 30 g/m².

Surprisingly, the efficiency of the process of the present invention is superior compared with the processes known in the art. In particular, a passivation of the surface of the casting cylinder, as is necessary with chromium plated casting cylinders, is not necessary with the casting cylinder of the present invention. Consequently, the downtime of the cast coating device is reduced.

Due to abrasion of the casting cylinder, the quality of the paper produced will gradually decrease. Therefore, the casting cylinder of the cast coating device has to be changed. Surprisingly, the lifetime of the casting cylinder of the cast coating device of the present invention is enhanced significantly. It can be used at least twice as long as a casting cylinder known in the art before it has to be replaced.

A further advantage of the present invention is that the cast coating paper produced has a lower ink set-off time than a paper produced with a process known in the art, whereby the further advantageous properties of the paper are not changed significantly. In particular, the gloss and the smoothness of the paper are not changed. As a consequence of the lower ink set-off time, the paper is easier to usein offset printing. The offset ink penetrates more easily into the cast coated paper. There are no deposits of ink in the printed stack of paper.

The width of the web of paper which is pressed to the casting cylinder is generally smaller than the width of the casting cylinder. Consequently, the areas not covered by the web of paper show greater wear. In order to reduce wear, said areas of the cast coating cylinder are cooled. Cooling is performed by applying water, which results in the dilution of a release agent when the latter is being used. Surprisingly, using the cast coating cylinder of the present invention makes the cooling of areas not covered by the web of paper unnecessary. Thus, the release agent is not diluted any more, which enhances the efficiency of the cast coating process.

The present invention is exemplified by the following examples.

### EXAMPLES

The hardness of the casting cylinders of the subsequent examples have been measured according to DIN 50133.

### Example 1

A cast coating device was equipped with a cast coating cylinder having a width of 45 cm. The cylinder had a ceramic coating with a hardness value of 1100 HV. The cylinder was heated until the temperature of the surface of the cylinder was approximately 175° C. A roll was pressed to the cast coating cylinder surface at a nip pressure of approx. 1500 N/cm², whereby a release agent comprising 1 weight percent of waxes was dosed into the nip. The release agent had a pH value of approx. 3, and the cast coating cylinder had a peripheral speed of 50 m/min. There was no web of paper passing through the nip of cast coating cylinder and roll. After 4 weeks, the thickness of the ceramic coating of the cast coating cylinder was measured. The thickness of the ceramic coating had been reduced by 2 μm.

### Comparative Example 1

A cast coating device as described in Example 1 was used, with the difference that the cast coating cylinder had a chromium coating having a hardness value of 890 HV. After 4 weeks under the trial conditions as described in Example 1, the thickness of the chromium layer was measured again. The thickness of the chromium coating had been reduced by 10 μm.

### Example 2

A cast coated paper produced with a ceramic coated cast coating cylinder, whereby the ceramic coating had a hardness value of 1100 HV, was printed using a Heidelberger Speed Master printing machine. The ink set-off time was measured to be 2.5 minutes (full tone area having an ink coverage of 300 percent).

### Comparative Example 2

A cast coated paper produced with a conventional cast coating cylinder having a chromium coating (hardness 890 HV) was printed as described in Example 2. The only difference between the paper of Example 2 and Comparative Example 2 was the use of differently coated cast coating cylinders. The ink set-off time of Comparative Example 2 was measured to be 6 minutes, which is much more.

### Example 3

The wipe test is a method for determining the ink penetration of a test ink into cast coated papers. Said test ink comprises the same components as a conventional printing ink, with the exception that no colored pigments and binders are present in said test ink.

The chromaticity coordinate of the test paper is measured according to the Cielab system. Subsequently, the test ink is applied to the test paper. After 120 s the test ink is wiped off and the chromaticity coordinate is measured again according to the Cielab system. The difference of the a* values (Δa*) measured before and after applying the test ink is an indicator for the ink penetration into the test paper. A high Δa* value indicates a good ink penetration.

A test paper produced with a chromium cylinder (hardness 890 HV) had a Δa* value of 25, whereas a test paper produced with a ceramic coated cast coating cylinder having a hardness value of 1100 HV led to a test paper having a Δa* value of 36. The only difference in producing both test papers was the use of the specific coated cast coating cylinders. Due to the higher Δa* value of the paper produced with the cast coating cylinder having a ceramic coating, said paper had an improved ink penetration compared with a paper produced using a chromium plated cast coating cylinder.

1. A cast coating device for manufacturing cast coated paper and/or paperboard, comprising a cast coating cylinder for treating a coated base paper, the cast coating cylinder comprising a supporting material, and at least one coating being applied to the supporting material, the coating having a hardness value of 1000 HV or more according to DIN 50133.

2. The cast coating device according to claim 1, wherein the hardness of the coating of the cast coating cylinder is 1100 HV or more.

3. The cast coating device according to claim 1, wherein the coating applied to the supporting material of the cast coating cylinder is a ceramic coating.

4. The cast coating device according to claim 3, wherein the ceramic coating comprises a hard material selected from the group consisting of metal oxides, semimetal oxides, metal carbides, semimetal carbides, metal nitrides, semimetal nitrides, metal borides, semimetal borides or mixtures thereof.

5. The cast coating device according to claim 3, wherein the ceramic coating is a coating comprising at least one hard material in a metal matrix and/or metal oxide matrix, whereby the metal matrix and/or metal oxide matrix is preferably different from the hard material.

6. The cast coating device according to claim 5, wherein the metal matrix and/or metal oxide matrix comprises a self-flowing alloy, whereby said self-flowing alloy has been liquefied when applied to the supporting material.

7. The cast coating device according to claim 5, wherein the metal matrix and/or metal oxide matrix comprises at least one metal alloy selected from the group consisting of alloys of nickel, chromium, boron, silicon, cobalt or mixtures thereof, whereby said metal alloy is preferably a self-flowing alloy.

8. The cast coating device according to claim 1, wherein the roughness Rₐ of the coating of the cast coating cylinder is less than 1.0 μm, measured according to DIN 4762.

9. The cast coating device according to claim 1, wherein at least one coating of the cast coating cylinder is present on the supporting material of the cast coating cylinder which comes into contact with the coated base paper.

10. The cast coating device according to claim 1, wherein the cast coating device comprises a system for heating the cast coating cylinder.

11. The cast coating device according to claim 1, wherein it comprises a system for applying a coating composition to a base paper, whereby the means for applying the coating composition is arranged in the cast coating device so that the coating is applied to the base paper before the obtained coated base paper is brought into contact with the cast coating cylinder.

12. The cast coating device according to claim 1, wherein the cast coating device comprises a roll for pressing the coated base paper to the cast coating cylinder.

13. The cast coating device according to claim 1, wherein it comprises a means for removing the dried coated base paper from the cast coating cylinder.

14. A process for manufacturing cast coated paper and/or paperboard comprising the steps of:
(a) applying a coating composition to at least one surface of a base paper;
(b) bringing the coated base paper into contact with the surface of a heated cast coating cylinder in order to dry the coated base paper, the cast coating cylinder comprising a supporting material and at least one coating applied to the supporting material, whereby the coating has a hardness value of ≧1000 (DIN 50133); and
(c) removing the dried coated base paper from the cylinder surface.

15. The process of claim 14 whereby the coating composition applied to the base paper in step (a) is coagulated and/or solidified to a gel before being brought into contact with the cylinder surface in step (b).

16. The process of claim 14, whereby the coating composition applied to the base paper in step (a) is dried before being brought into contact with the cylinder surface in step (b), whereby the dried coat is remoistened before or simultaneously when being brought into contact with the cylinder surface.

17. The process of claim 14, whereby in step (b) the cylinder surface has a temperature of from 80° C. to 160° C.

18. The process of claim 14, wherein in step (b) the coated base paper is pressed to the cylinder surface by means of a roll at a nip pressure of at least 1000 N/cm².

19. The process of claim 14, wherein in step (a) the coating composition applied to the base paper has a coat weight (oven-dry) of from 10 to 30 g/m².
